(19) United States
(12) Patent Application Publication
(10) Pub. No.: US 2005/0147011 A1
(43) Pub. Date: Jul. 7, 2005

(54) Optical integrated device

(75) Inventors: Shinya Esaki, Osaka (JP); Masaki Taniguchi, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/022,816

(22) Filed: Dec. 28, 2004

(30) Foreign Application Priority Data
Jan. 7, 2004 (JP) 2004-2432

(51) Int. Cl. G11B 7/00

(52) U.S. Cl. 369/53.37; 369/124.1

(57) ABSTRACT

An optical integrated device includes a light source, a light-receiving element, a signal processing section, and a sleep control circuit. The light source irradiates a light beam onto an optical recording medium. The light-receiving element receives a reflected light of the light beam from the optical recording medium and outputs an electrical signal according to the reflected light. The signal processing section performs predetermined processing on the electrical signal outputted from the light-receiving element. The sleep control circuit is connected to a terminal which outputs a signal indicating the operation voltage of the light source, and controls whether to put the signal processing section in an operation state or a low power consumption state based on the voltage at the terminal.

### BACKGROUND OF THE INVENTION

1. Field of the Invention

The present invention relates to an optical integrated device and a signal processing apparatus. More particularly, the present invention relates to an optical integrated device mainly used for optical pickups and optical disk apparatuses, and a signal processing apparatus using such an optical integrated device, which is typified by a signal processing apparatus for optical recording media.

2. Description of the Background Art

FIG. 13 is a diagram illustrating a configuration of a conventional optical integrated device. When a light beam is irradiated from a light source 91 onto an optical recording medium (not shown), the reflected light of the light beam is received by light-receiving elements 92 and a current according to the reflected light is generated in the light-receiving elements 92. In this case, a control signal which causes current/voltage conversion amplifiers 93 to operate is inputted to a sleep control terminal 95. In response to the control signal, a sleep control circuit 94 supplies power to the current/voltage conversion amplifiers 93. Accordingly, the current/voltage conversion amplifiers 93 convert the currents generated in the respective light-receiving elements 92 into voltages and then output the converted voltages. On the other hand, in the case where a light beam is not irradiated from the light source 91, a control signal which causes the current/voltage conversion amplifiers 93 to enter a low power consumption state (hereinafter referred to as a “sleep state”) is inputted to the sleep control terminal 95. When this control signal is inputted, the sleep control circuit 94 does not supply power to the current/voltage conversion amplifiers 93. By performing these operations, the optical integrated device shown in FIG. 13 puts the current/voltage conversion amplifiers 93 in a sleep state when the light source 91 is not in operation, thereby achieving a reduction in power consumption. The optical integrated device shown in FIG. 13 performs a sleep control by inputting the above-described control signal from the outside of the optical integrated device.

In conventional techniques, performing a sleep control on an optical integrated device requires a control signal which is inputted from the outside of the optical integrated device. Accordingly, a sleep control terminal used to input the control signal is required, causing an increase in the number of terminals in the optical integrated device. On the other hand, if the sleep control terminal is not provided, the optical integrated device is kept in operation at all times, causing an increase in power consumption of the optical integrated device.

### SUMMARY OF THE INVENTION

Therefore, an object of the present invention is to provide an optical integrated device which achieves a reduction in the number of terminals and a reduction in power consumption by performing a sleep control.

The present invention has the following features to attain the object mentioned above. Specifically, a first aspect of the present invention is directed to an optical integrated device comprising: a light source for irradiating a light beam onto an optical recording medium; a first light-receiving element for receiving a reflected light of the light beam from the optical recording medium and outputting an electrical signal according to the reflected light; a signal processing section for performing predetermined processing on the electrical signal outputted from the first light-receiving element; and a sleep control circuit connected to a terminal which outputs a signal indicating an operation voltage of the light source, for controlling whether to put the signal processing section in an operation state or a low power consumption state based on the voltage at the terminal.

A second aspect of the present invention is directed to an optical integrated device comprising: a light source for irradiating a light beam onto an optical recording medium; a first light-receiving element for receiving a reflected light of the light beam from the optical recording medium and outputting an electrical signal according to the reflected light; a signal processing section for performing predetermined processing on the electrical signal outputted from the first light-receiving element; a second light-receiving element for receiving the light beam irradiated from the light source, and outputting an electrical signal which indicates an amount of the light beam; and a sleep control circuit for controlling whether to put the signal processing section in an operation state or a low power consumption state based on the electrical signal outputted from the second light-receiving element.

In the second aspect, the optical integrated device may further comprise a current/voltage conversion amplifier for converting a current value of the electrical signal outputted from the second light-receiving element into a voltage value. In this case, the sleep control circuit may control whether to put the signal processing section in an operation state or a low power consumption state based on the voltage value converted by the current/voltage conversion amplifier.

In the second aspect, the optical integrated device may further comprise a current mirror circuit for amplifying a current value of the electrical signal outputted from the second light-receiving element and then converting the amplified current value into a voltage value. In this case, the sleep control circuit may control whether to put the signal processing section in an operation state or a low power consumption state based on the voltage value converted by the current mirror circuit.

In the first aspect, the voltage at the terminal and a predetermined reference voltage may be inputted to the sleep control circuit, and the sleep control circuit may include a comparator with hysteresis.

In the second aspect, a voltage whose magnitude is proportional to a current value of the electrical signal outputted from the second light-receiving element, and a predetermined reference voltage may be inputted to the sleep control circuit, and the sleep control circuit may include a comparator with hysteresis.

In the first aspect, the sleep control circuit may put the signal processing section in a low power consumption state when a value of the voltage at the terminal continuously indicates for a predetermined period of time that the light source is not in operation.

In the second aspect, the sleep control circuit may put the signal processing section in a low power consumption state when the electrical signal outputted from the second light-receiving element continuously indicates for a predetermined period of time that the light source is not in operation.

In the first and second aspects, typically, the sleep control circuit may measure the predetermined period of time using a clock signal.

Alternatively, in the first and second aspects, the optical integrated device may further comprise a time measurement circuit having a capacitor which is charged by a voltage at a terminal which outputs a signal indicating an operation voltage of the light source. In this case, the sleep control circuit may put the signal processing section in a low power consumption state when a terminal voltage of the capacitor changes to a voltage less than a predetermined value.

In the first and second aspects, the optical integrated devices may further comprise a low-pass filter to be connected to a signal input side of the sleep control circuit.

The present invention may be provided in the form of a signal processing apparatus which comprises the optical integrated device according to either the first or second aspect, and performs predetermined processing on a signal having been subjected to predetermined processing in a signal processing section.

According to the present invention, since it is not necessary to input a control signal from the outside of the optical integrated device, there is no need to provide a sleep control terminal to the optical integrated device. Accordingly, the number of terminals in the optical integrated device can be reduced. In addition, since a sleep control can be performed within the optical integrated device, even an optical pickup which does not have a sleep control terminal is able to perform a sleep control in the optical integrated device, whereby the standby power consumption can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a configuration of an optical integrated device according to a first embodiment;

FIG. 2 is a diagram illustrating an exemplary optical integrated device having a sleep control circuit 4 composed of a transistor;

FIGS. 3A and 3B are diagrams for describing the operation of a comparator with hysteresis;

FIG. 4 is a diagram illustrating a configuration of an optical integrated device according to a second embodiment;

FIG. 5 is a diagram showing the input and output signals of a sleep control circuit 4 in the second embodiment;

FIG. 6 is a diagram showing the input and output signals of a time measurement circuit 5 and a sleep control circuit 4 in a variation of the second embodiment;

FIG. 7 is a diagram illustrating a configuration of an optical integrated device according to a third embodiment;

FIG. 8 is a diagram illustrating a configuration of an optical integrated device according to a fourth embodiment;

FIG. 9 is a diagram illustrating a configuration of an optical integrated device according to a variant of the first embodiment;

FIG. 10 is a diagram illustrating a configuration of an optical integrated device according to a variant of the second embodiment;

FIG. 11 is a diagram illustrating a configuration of an optical integrated device according to a variant of the third embodiment;

FIG. 12 is a diagram illustrating a configuration of an optical integrated device according to a variant of the fourth embodiment; and

FIG. 13 is a diagram illustrating a configuration of a conventional optical integrated device.

### DESCRIPTION OF THE PREFERRED EMBODIMENTS

### First Embodiment

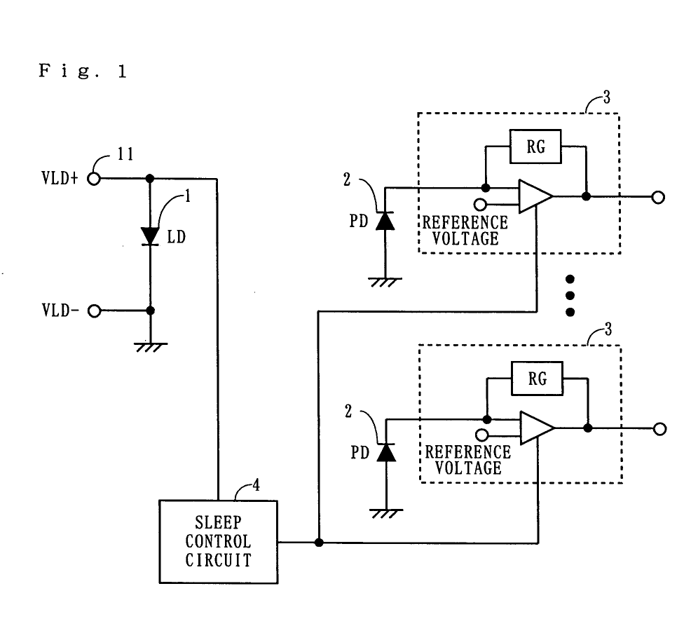

An optical integrated device according to a first embodiment of the present invention will be described. FIG. 1 is a diagram illustrating a configuration of an optical integrated device according to the first embodiment. In FIG. 1, the optical integrated device includes a light source 1, light-receiving elements 2, current/voltage conversion amplifiers 3, and a sleep control circuit 4. The optical integrated device shown in FIG. 1 is typically used in optical disk apparatuses for reading information recorded on optical recording media. The light source 1 is a semiconductor laser and irradiates a light beam onto an optical recording medium (not shown). Note that a cathode-side terminal of the semiconductor laser, which serves as the light source 1, is grounded to GND. The light-receiving element 2 is a photodiode and receives a reflected light of the light beam from the optical recording medium. In FIG. 1, a plurality of light-receiving elements 2 are provided; however any number of light-receiving elements 2 can be provided. The number of current/voltage conversion amplifiers 3 is equal to the number of light-receiving elements 2. One input terminal of each current/voltage conversion amplifier 3 is connected to the cathode side of each light-receiving element 2, and a predetermined reference voltage is inputted to the other input terminal of each current/voltage conversion amplifier 3. The sleep control circuit 4 has an input terminal connected to the anode side of the light source 1, and an output terminal connected to each current/voltage conversion amplifier 3. Specifically, the output terminal of the sleep control circuit 4 is connected to a power supply terminal of an operational amplifier included in the current/voltage conversion amplifier 3.

The operation of the optical integrated device shown in FIG. 1 will be described below. The sleep control circuit 4 determines, based on the operation state of the light source 1, whether to put the current/voltage conversion amplifiers 3 in an operation state or a sleep state. Specifically, when the light source 1 is in operation, the sleep control circuit 4 puts the current/voltage conversion amplifiers 3 in an operation state, and when the light source 1 is not in operation, the sleep control circuit 4 puts the current/voltage conversion amplifiers 3 in a sleep state. In the first embodiment, the sleep control circuit 4 measures the voltage across the semiconductor laser. Note that although the voltage between the terminals of the semiconductor laser being in operation varies depending on the type of the semiconductor laser, or the like, a red laser has a voltage of about 2.5 to 3.0 (V) and an infrared laser has a voltage of about 2 (V). If the voltage between the terminals of the semiconductor laser has such values, the sleep control circuit 4 determines that the semiconductor laser is in operation and thus puts the current/voltage conversion amplifiers 3 in an operation state. On the other hand, if the voltage between the terminals of the semiconductor laser does not reach such values, the sleep control circuit 4 determines that the semiconductor laser is not in operation and thus puts the current/voltage conversion amplifiers 3 in a sleep state.

Specifically, the voltage at the anode-side terminal 11 of the light source 1 is inputted to the sleep control circuit 4. If the voltage at the terminal 11 is equal to or greater than a predetermined threshold value, the sleep control circuit 4 supplies power to the current/voltage conversion amplifiers 3, and if the voltage at the terminal 11 is less than the predetermined threshold value, the sleep control circuit 4 does not supply power to the current/voltage conversion amplifiers 3. The predetermined threshold value is set to a value which is lower than the anode-side voltage of the light source 1 being in operation and which is higher than the anode-side voltage of the light source 1 not being in operation. More specifically, the predetermined threshold value is preferably set to a value which is about 20 to 30 percent lower than the voltage of the semiconductor laser being in operation which serves as the light source 1.

When the optical pickup included in the optical disk apparatus is in operation, the light source 1 is also in operation, and thus a certain voltage is applied to the anode-side terminal 11 of the light source 1. Hence, the voltage at the terminal 11 is greater than the above-described predetermined threshold value, and accordingly the sleep control circuit 4 determines that the light source 1 is in operation and thus allows each current/voltage conversion amplifier 3 to operate. As a result, the currents generated in the light-receiving elements 2 having received the reflected light of the light beam from the light source 1, are converted into voltages by the current/voltage conversion amplifiers 3. Signals of the converted voltages are the output of the optical integrated device. In another embodiment, the current/voltage conversion amplifiers 3 may be other types of signal processing circuits. The circuit to perform a sleep control may be any circuit as long as the circuit performs some kind of signal processing on the signals generated in the light-receiving elements 2.

When the optical pickup included in the optical disk apparatus is not in operation, the light source 1 is not in operation, either, and thus the voltage across the light source 1 is 0. Hence, the voltage at the terminal 11 is less than the above-described predetermined threshold value, and accordingly the sleep control circuit 4 determines that the light source 1 is not in operation and thus puts each current/voltage conversion amplifier 3 in a sleep state. In this case, since power is not supplied to the current/voltage conversion amplifiers 3, a reduction in power consumption of the current/voltage conversion amplifiers 3 is achieved.

A specific configuration example of the sleep control circuit 4 includes a comparator, for example. In this case, the comparator is set to switch the output at a voltage of the above-described predetermined threshold value.

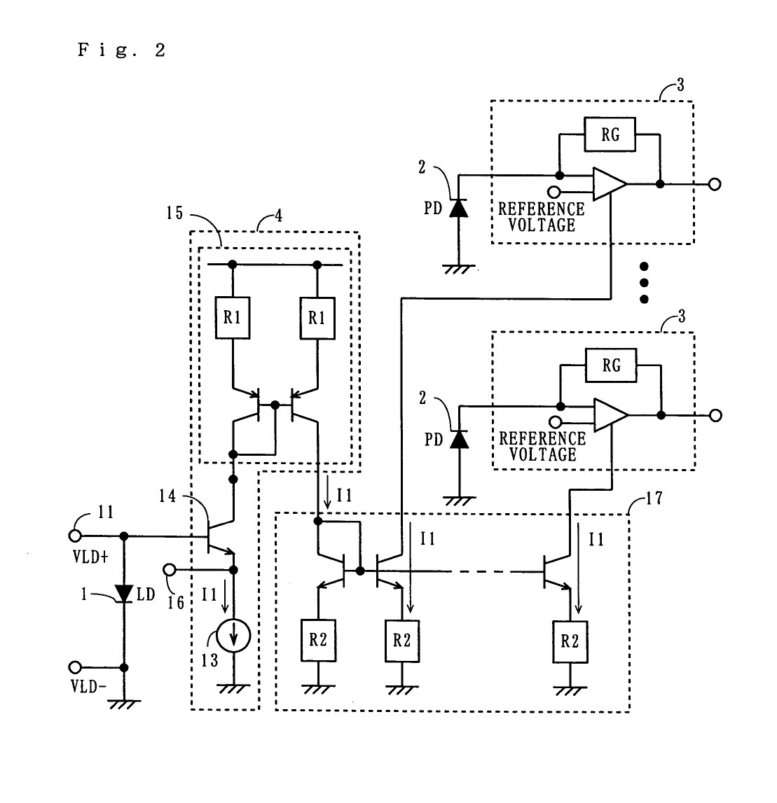

Alternatively, the sleep control circuit 4 may be composed of a transistor. FIG. 2 is a diagram illustrating an exemplary optical integrated device having a sleep control circuit 4 composed of a transistor. In FIG. 2, the sleep control circuit 4 includes a current source 13, a sleep control circuit input transistor 14, and a current mirror circuit 15 for controlling a circuit current. The current source 13 supplies a reference current 11 to the current mirror circuit 15 and is connected to the emitter side of the sleep control circuit input transistor 14. The current mirror circuit 15 having outputs the number of which is equal to the number of current/voltage conversion amplifiers 3, is connected to the collector side of the sleep control circuit input transistor 14. In addition, a terminal 11 is connected to the base side of the sleep control circuit input transistor 14. Note that in the configuration shown in FIG. 2 a current mirror circuit 17 for supplying a circuit current is connected to the output side of the sleep control circuit 4.

In the configuration shown in FIG. 2, the emitter voltage of the sleep control circuit input transistor 14 is set as follows: (Emitter voltage)=(Control reference voltage VTH)−(Voltage between the base and emitter of the transistor), where the control reference voltage VTH is the voltage at the terminal 16 shown in FIG. 2. In the case where the emitter voltage is set in this manner, the sleep control circuit 4 operates as follows. Specifically, when the optical integrated device enters an operation state, the voltage at the terminal 11 increases. Then, when the voltage at the terminal 11 reaches the control reference voltage VTH or greater, the sleep control circuit input transistor 14 operates and the reference current I1 flows through the current mirror circuit 15. As a result, through the current mirror circuit 17, the current Il is supplied to each current/voltage conversion amplifier 3. On the other hand, when the optical integrated device is not in operation, the voltage at the terminal 11 is less than the control reference voltage VTH and thus the sleep control circuit input transistor 14 is turned off. Accordingly, a current does not flow through the current mirror circuit 15 and thus the current/voltage conversion amplifiers 3 enter a sleep state.

In addition to the circuit composed of a comparator and the circuit shown in FIG. 2, the sleep control circuit 4 may be configured as follows. Specifically, in another example where a transistor is used on the input side of the sleep control circuit 4, a circuit may be used which supplies a current n times greater than the original current by changing the mirror ratios of the current mirror circuit 15 and the current mirror circuit 17 using resistors. Alternatively, the sleep control circuit input transistor 14 may be composed of a PNP transistor in which when the output of the semiconductor laser is turned off, the input transistor operates and the circuit supply current is pulled through the sleep circuit, thereby prohibiting the supply of the current to the sleep circuit.

As described above, according to the first embodiment, since the input of the sleep control circuit 4 is connected to the inside of the optical integrated device, it is not necessary to provide a control terminal for controlling the sleep control circuit 4, whereby the number of terminals in the optical integrated device can be reduced. In addition, since the sleep control circuit 4 can be controlled within the optical integrated device, it is not necessary to generate a control signal outside the optical integrated device.

In the optical pickup, when playing back an optical recording medium, a high-frequency signal (e.g., 300 (MHz)) which does not affect the signal of the optical integrated device is superimposed on a signal to be inputted to the laser. Thus, the terminal voltage VLD+ may be affected and changed by about 0.2 (V). Due to this change, the sleep control circuit 4 may malfunction. To prevent such a malfunction, a comparator with hysteresis may be used as the sleep control circuit 4.

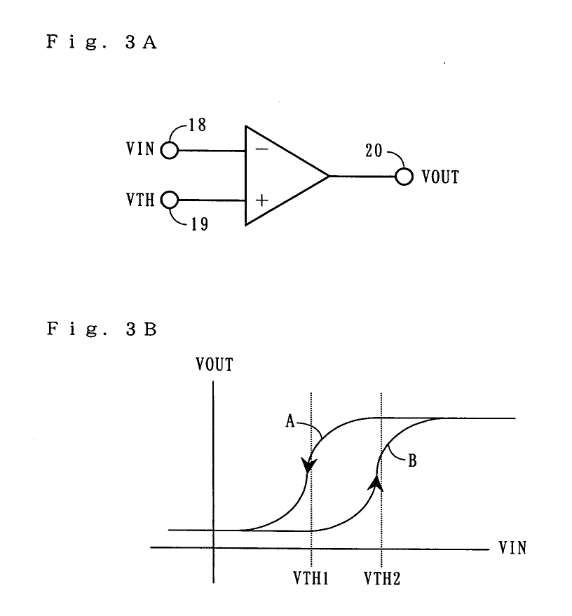

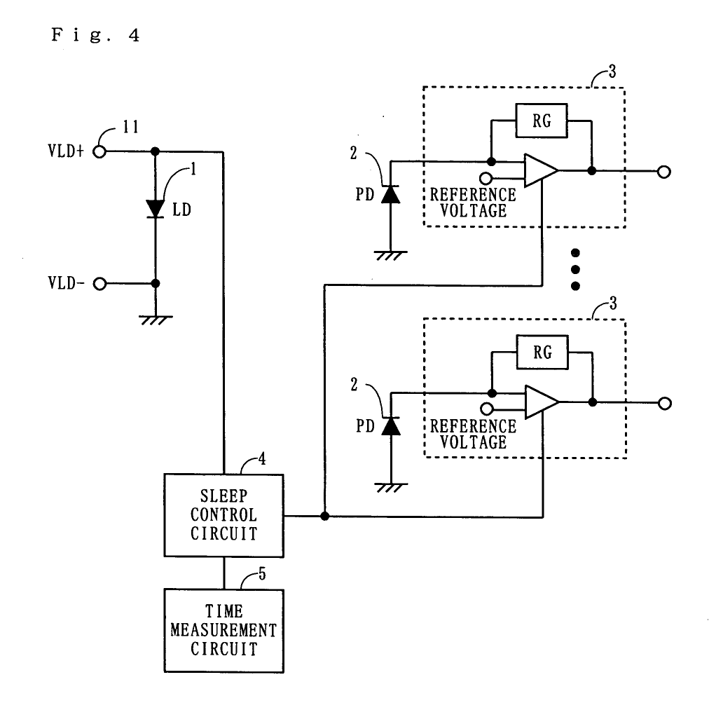

FIGS. 3A and 3B are diagrams for describing the operation of a comparator with hysteresis. Note that in this example an input terminal 18 of a comparator shown in FIG. 3A serves as the input terminal of a sleep control circuit 4 and an output terminal 20 serves as the output of the sleep control circuit 4. In addition, a voltage VTH of a predetermined threshold value is applied to an input terminal 19 of the comparator. In the case where an input voltage VIN of the comparator increases gradually, the input and output relationship of the comparator has characteristics such as those indicated by a curve B shown in FIG. 3B. In this case, at the point where the input voltage VIN=VTH2, the output of the comparator is high. On the other hand, in the case where the semiconductor laser changes from its operation state to an off state, the input and output relationship of the comparator has characteristics such as those indicated by a curve A shown in FIG. 3B. In this case, at the point where the input voltage VIN=VTH1, the output of the comparator is low. In the case where a comparator having the above-described hysteresis is used as the sleep control circuit 4, by setting the potential difference between VTH1 and VTH2 to a value equal to or greater than the voltage change caused by superimposition of a high-frequency signal, the sleep control can be performed properly without causing the sleep control circuit 4 to be affected by the superimposition of a high-frequency signal.

In another example of preventing a malfunction caused by superimposition of a high-frequency signal, a method using a low-pass filter may be performed. Specifically, a low-pass filter is inserted between the terminal 11 and the input side of the sleep control circuit 4. In this case, the cutoff frequency of the low-pass filter is set to such a frequency that is not affected by superimposition of a high-frequency signal. For example, in the case of superimposing a high-frequency signal of 300 (MHz), the cutoff frequency may be set to 1 (MHz), for example. The use of such a low-pass filter also prevents the sleep control circuit 4 from being affected by super imposition of a high-frequency signal, and accordingly it is possible to prevent the sleep control circuit 4 from malfunctioning. Note that in second to fourth embodiments (described later) too a low-pass filter may be provided on the input side of the sleep control circuit 4.

### Second Embodiment

An optical integrated device according to a second embodiment of the present invention will be described. The optical integrated device according to the second embodiment aims to prevent current/voltage conversion amplifiers 3 from entering a sleep state when the drive voltage of a semiconductor laser temporarily decreases due to external factors, a malfunction, or the like.

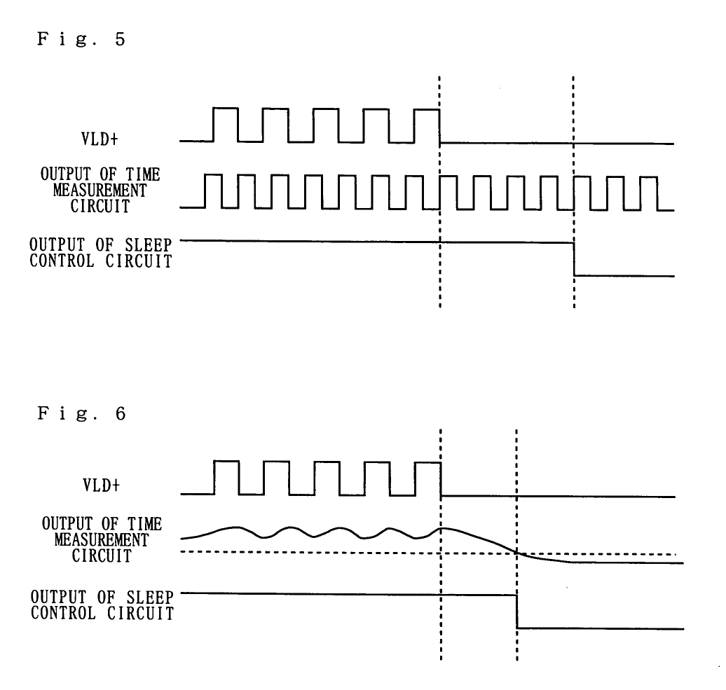

FIG. 4 is a diagram illustrating a configuration of the optical integrated device according to the second embodiment. In FIG. 4, the optical integrate'd device further includes a time measurement circuit 5 in addition to the components shown in FIG. 1. Note that in FIG. 4 the same components as those shown in FIG. 1 are designated by the same reference numerals, and the description thereof will be omitted.

In FIG. 4, the time measurement circuit 5 is connected to a sleep control circuit 4. The time measurement circuit 5 outputs a clock signal having a predetermined cycle to the sleep control circuit 4. In the second embodiment, when the voltage VLD+ of a terminal 11 becomes less than a predetermined threshold value, the sleep control circuit 4 stops supplying power to current/voltage conversion amplifiers 3 while a predetermined number or more of pulses of the clock signal is being inputted to the sleep control circuit 4.

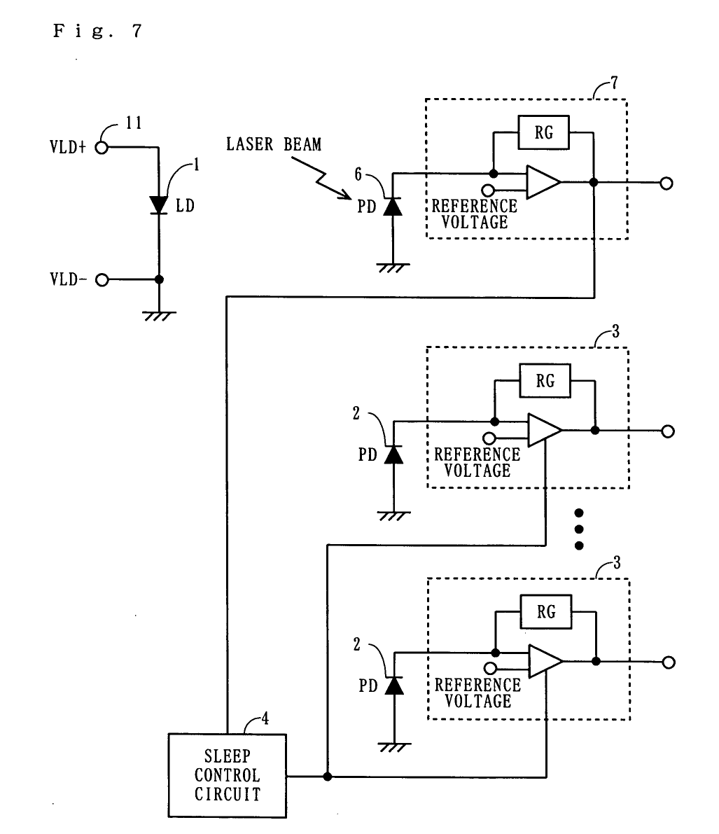

FIG. 5 is a diagram showing the input and output signals of the sleep control circuit 4 in the second embodiment. In FIG. 5, the top line indicates an input signal from the terminal 11, the middle line indicates an input signal from the time measurement circuit 5, and the bottom line indicates an output signal to the current/voltage conversion amplifiers 3. As shown in FIG. 5, the sleep control circuit 4 changes the output signal based on the input signal from the terminal 11 and the input signal from the time measurement circuit 5. Specifically, the sleep control circuit 4 brings, when the voltage of the input signal from the terminal 11 becomes less than a predetermined threshold value, the output signal to a low level while a predetermined number or more of pulses of the clock signal is being inputted to the sleep control circuit 4. In response to the output signal having been brought to a low level, the current/voltage conversion amplifiers 3 enter a sleep state.

As described above, according to the second embodiment, only when the voltage VLD+ of the terminal 11 becomes less than a predetermined threshold value, the current/voltage conversion amplifiers 3 enter a sleep state only for a predetermined period of time (a period of time during which a predetermined number of pulses of the clock signal is being inputted to the sleep control circuit 4). Therefore, by appropriately setting the predetermined period of time, it is possible to prevent the transition of the current/voltage conversion amplifiers 3 to a sleep state resulting from a temporary decrease in the drive voltage of the semiconductor laser due to external factors, a malfunction, or the like.

In the second embodiment, the time measurement circuit 5 which outputs a clock signal may be configured using a time constant circuit fabricated with a capacitor and a resistor. In this case, the voltage at the terminal 11 is inputted to the time constant circuit, and the output signal of the time constant circuit is inputted to the sleep control circuit 4. The time constant circuit monitors the terminal voltage of the light source 1, and charges an electric charge in the capacitor when the semiconductor laser is in operation and discharges the electric charge from the capacitor when the semiconductor laser is not in operation.

The input and output signals of the time constant circuit and the sleep control circuit 4 for the above case are shown in FIG. 6. FIG. 6 is a diagram showing the input and output signals of the time measurement circuit 5 and the sleep control circuit 4 in a variation of the second embodiment. In FIG. 6, the top line indicates a signal inputted to the time measurement circuit 5 from the terminal 11, the middle line indicates a signal inputted to the sleep control circuit 4 from the time measurement circuit 5, and the bottom line indicates a signal outputted to the current/voltage conversion amplifiers 3 from the sleep control circuit 4. As shown in FIG. 6, when the semiconductor laser is not in operation, the electric charge being charged in the capacitor is discharged and the terminal voltage of the capacitor decreases with time. In the case where the semiconductor laser does not operate for a predetermined period of time and thereby the terminal voltage of the capacitor decreases and accordingly becomes less than a predetermined threshold value, the sleep control circuit 4 puts the time constant circuit in a sleep state. Note that the time in which the terminal voltage of the capacitor in the time constant circuit becomes less than the predetermined threshold value can be set to any desired value using the capacitor and resistor included in the time constant circuit. By the above-described configuration too, the same advantage as that obtained by the second embodiment can be obtained.

### Third Embodiment

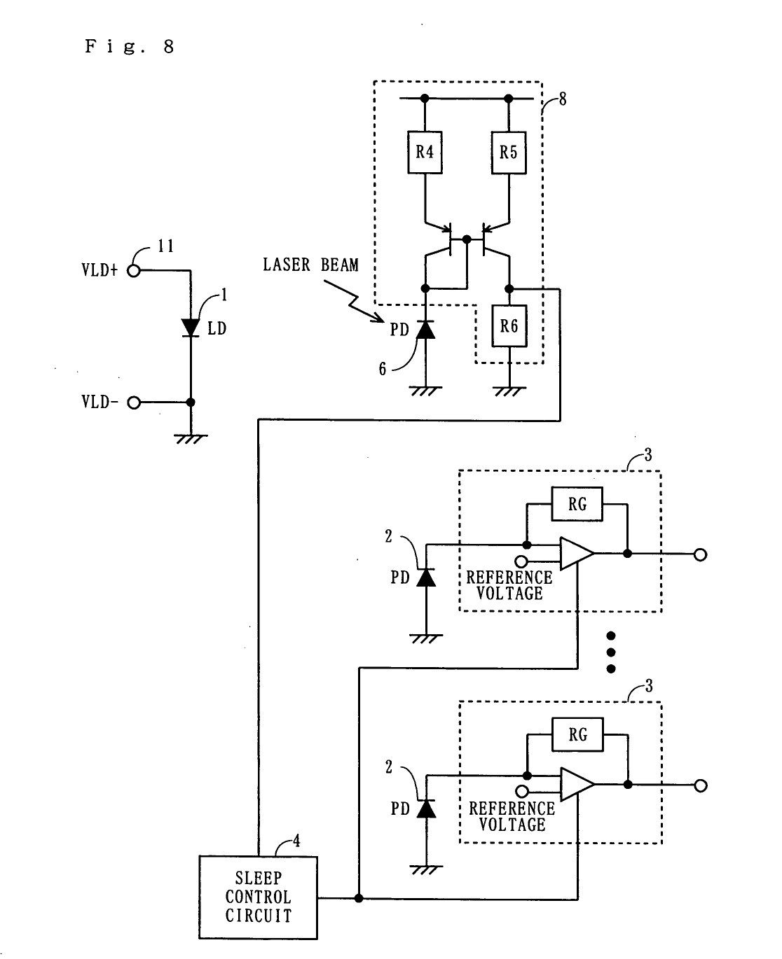

An optical integrated device according to a third embodiment of the present invention will be described. The optical integrated device according to the third embodiment performs a sleep control by monitoring a light beam from a light source 1 instead of monitoring the voltage across the light source 1. FIG. 7 is a diagram illustrating a configuration of the optical integrated device according to the third embodiment. In FIG. 7, the optical integrated device further includes a light-receiving element 6 for detecting a laser beam and a current/voltage conversion amplifier 7, in addition to the components shown in FIG. 1. The light-receiving element 6 is a photodiode and the cathode side of the light-receiving element 6 is connected to one input terminal of the current/voltage conversion amplifier 7. In the third embodiment, an input terminal of a sleep control circuit 4 is connected to an output terminal of the current/voltage conversion amplifier 7 instead of to a terminal 11. Except for these differences, the configuration of the optical integrated device according to the third embodiment is the same as that shown in FIG. 1, and thus in FIG. 7 the same components as those shown in FIG. 1 are designated by the same reference numerals, and the description thereof will be omitted.

In FIG. 7, the light-receiving element 6 receives a light beam from the light source 1 and thereby generates a current. The generated current is converted into a voltage by the current/voltage conversion amplifier 7. Note that the current/voltage conversion amplifier 7 has the same configuration as the current/voltage conversion amplifiers 3. In the third embodiment, the sleep control circuit 4 determines whether to put the current/voltage conversion amplifiers 3 in a sleep state based on the value of the voltage outputted from the current/voltage conversion amplifier 7. Specifically, if the value of the voltage outputted from the current/voltage conversion amplifier 7 is equal to or higher than a predetermined threshold value, the sleep control circuit 4 supplies power to the current/voltage conversion amplifiers 3 and puts the current/voltage conversion amplifiers 3 in an operation state. On the other hand, if the value of the voltage outputted from the current/voltage conversion amplifier 7 is less than the predetermined threshold value, the sleep control circuit 4 stops supplying power to the current/voltage conversion amplifiers 3 and puts the current/voltage conversion amplifiers 3 in a sleep state.

As described above, according to the third embodiment, as with the first embodiment, the input of the sleep control circuit 4 is connected to the inside of the optical integrated device. Therefore, it is not necessary to provide a control terminal for controlling the sleep control circuit 4, whereby the number of terminals in the optical integrated device can be reduced. In addition, since the sleep control circuit 4 can be controlled within the optical integrated device, it is not necessary to generate a control signal outside the optical integrated device.

In the third embodiment too, the sleep control circuit 4 may have the same configuration as that of the first embodiment. In addition, the optical integrated device according to the third embodiment may further include a time measurement circuit shown in the second embodiment.

### Fourth Embodiment

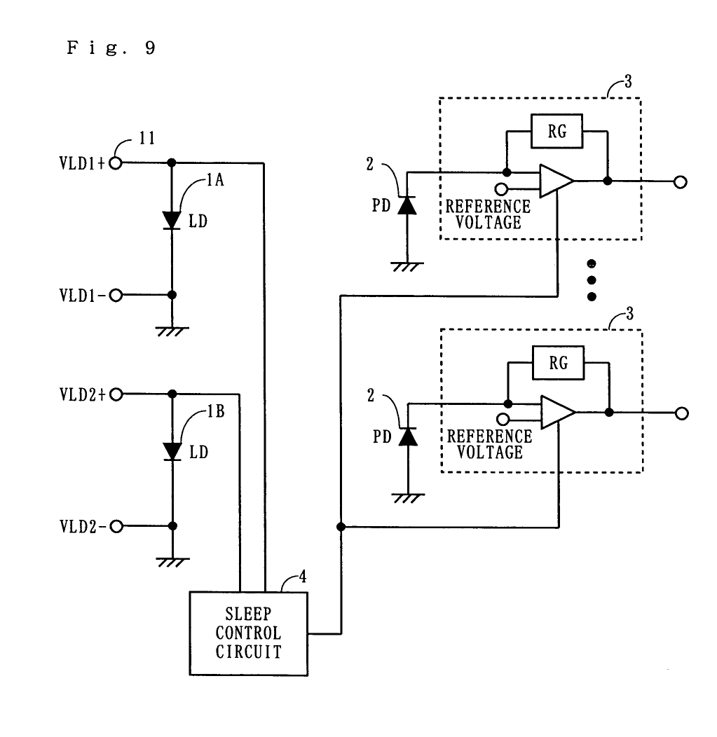

An optical integrated device according to a fourth embodiment of the present invention will be described. The optical integrated device according to the fourth embodiment uses a current mirror circuit in place of the current/voltage conversion amplifier 7 of the third embodiment. FIG. 8 is a diagram illustrating a configuration of the optical integrated device according to the fourth embodiment. In FIG. 8, the optical integrated device has a current mirror circuit 8 in place of the current/voltage conversion amplifier 7 shown in FIG. 7. Except forth is difference, the configuration of the optical integrated device according to the fourth embodiment is the same as that shown in FIG. 7, and thus in FIG. 8 the same components as those shown in FIG. 7 are designated by the same reference numerals, and the description thereof will be omitted.

In FIG. 8, when a light-receiving element 6 for detecting a laser beam receives a light beam from a semiconductor laser and thereby generates a current, the current which is R4/R5 times the generated current flows through a resistor R6 of the current mirror circuit 8. In the fourth embodiment, a sleep control circuit 4 determines whether to put current/voltage conversion amplifiers 3 in a sleep state based on the value of the voltage across the resistor R6. Specifically, if the value of the voltage across the resistor R6 is equal to or lower than a predetermined threshold value, the sleep control circuit 4 determines that a light source 1 is not in operation and thus puts the current/voltage conversion amplifiers 3 in a sleep state. On the other hand, if the value of the voltage across the resistor R6 is higher than the predetermined threshold value, the sleep control circuit 4 determines that the light source 1 is in operation and thus puts the current/voltage conversion amplifiers 3 in an operation state. Note that although the output current of the light-receiving element 6 is made R4/R5 times greater than the original current, the multiplication factor is preferably set such that the current mirror circuit 8 does not saturate at a voltage to be generated in the resistor R6.

With the above-described fourth embodiment too, the same advantage as that obtained by the third embodiment can be obtained. Note that the sleep control circuit may have the same configuration as that of the first embodiment. In addition, the optical integrated device according to the fourth embodiment may further include a time measurement circuit shown in the second embodiment.

(Variants)

The foregoing first to fourth embodiments describe the case where there is a single light source. In another embodiment, aplurality of light sources may be provided. Embodiments in which there are a plurality of light sources will be described below as the variants of the foregoing first to fourth embodiments.

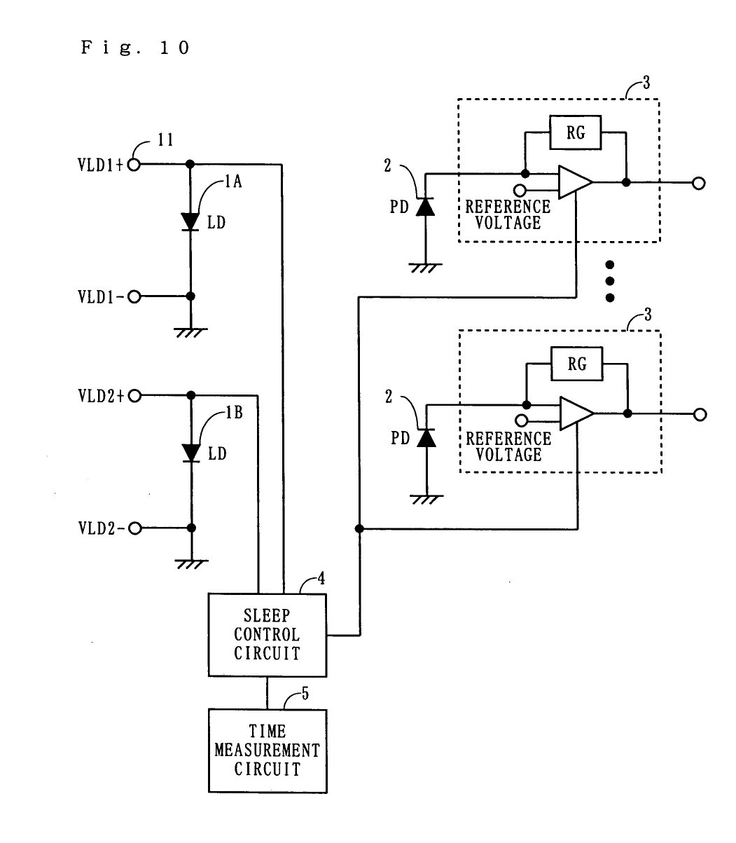

FIG. 9 is a diagram illustrating a configuration of an optical integrated device according to a variant of the first embodiment. In FIG. 9, the optical integrated device includes two light sources 1A and 1B which irradiate laser beams of different wavelengths. In FIG. 9, if either the light source 1A or 1B is in operation, current/voltage conversion amplifiers 3 need to enter an operation state. Therefore, a sleep control circuit 4 monitors a voltage value VLD1+ of the light source 1A and a voltage value VLD2+ of the light source 1B. Then, if both voltage values VLD1+ and VLD2+ are lower than a predetermined threshold value, the sleep control circuit 4 puts the current/voltage conversion amplifiers 3 in a sleep state. On the other hand, if either voltage value VLD1+ or VLD2+ is equal to or higher than the predetermined threshold value, the sleep control circuit 4 puts the current/voltage conversion amplifiers 3 in an operation state.

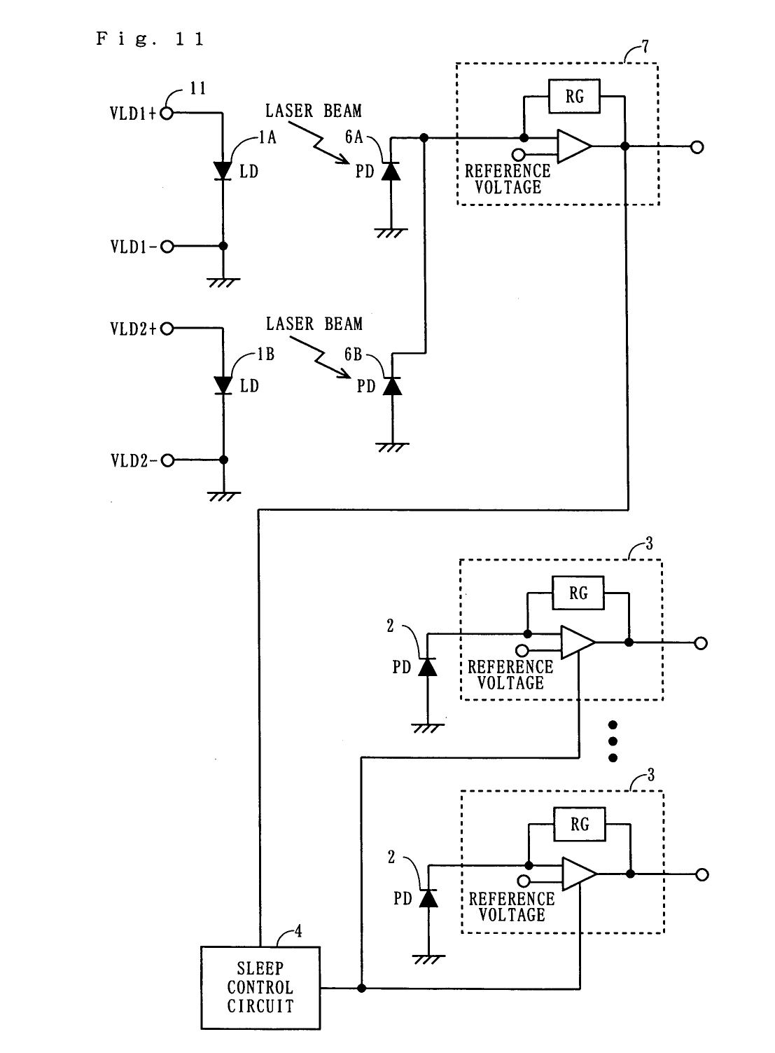

FIG. 10 is a diagram illustrating a configuration of an optical integrated device according to a variant of the second embodiment. In FIG. 10, the optical integrated device includes two light sources 1A and 1B which irradiate laser beams of different wavelengths. In FIG. 10, as with FIG. 9, if either the light source 1A or 1B is in operation, current/voltage conversion amplifiers 3 need to enter an operation state. Thus, when both voltage values VLD1+ and VLD2+ are lower than a predetermined threshold value, a sleep control circuit 4 puts the current/voltage conversion amplifiers 3 in a sleep state while a predetermined number or more of pulses of the clock signal is being inputted from a time measurement circuit 5. On the other hand, if either voltage value VLD1+ or VLD2+ is equal to or higher than the predetermined threshold value, the sleep control circuit 4 puts the current/voltage conversion amplifiers 3 in an operation state.

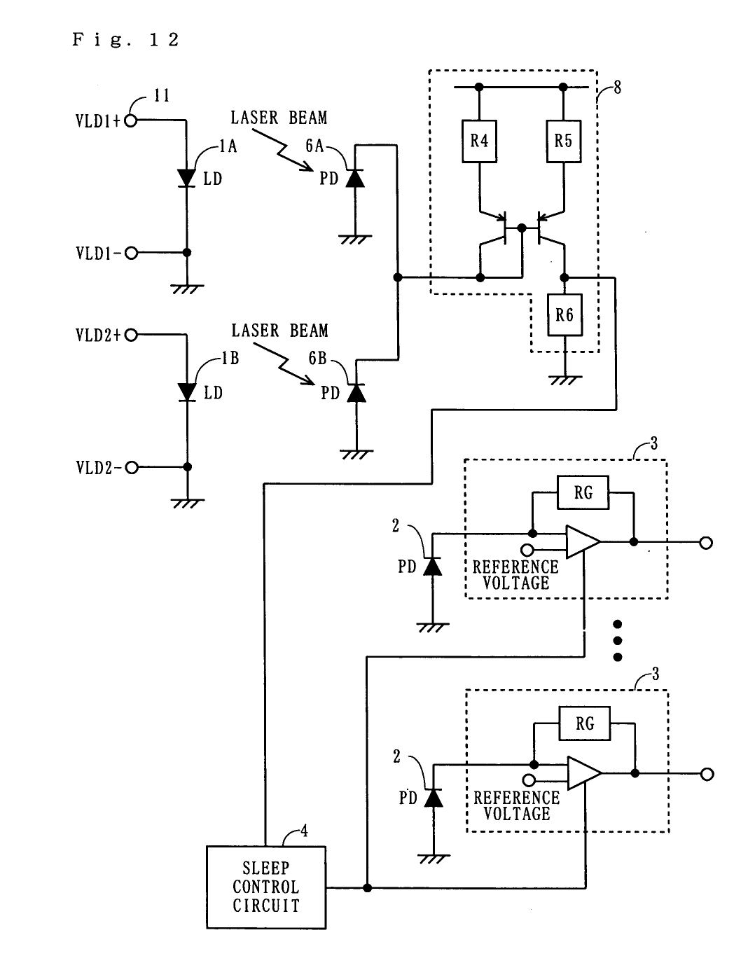

FIG. 11 is a diagram illustrating a configuration of an optical integrated device according to a variant of the third embodiment. In FIG. 11, the optical integrated device includes two light sources 1A and 1B which irradiate laser beams of different wavelengths. In addition, the optical integrated device includes a light-receiving element 6A for receiving a light beam from the light source 1A; and a light-receiving element 6B for receiving a light beam from the light source 1B. The cathode side of each of the light-receiving elements 6A and 6B is connected to an input terminal of a current/voltage conversion amplifier 7. In FIG. 11, as with FIG. 9, if either the light source 1A or 1B is in operation, current/voltage conversion amplifiers 3 need to enter an operation state. When either light-receiving element 6A or 6B receives a laser beam, the value of the voltage outputted from the current/voltage conversion amplifier 7 is equal to or higher than a predetermined threshold value. When neither light-receiving element 6A nor 6B receives a laser beam, the value of the voltage outputted from the current/voltage conversion amplifier 7 is lower than the predetermined threshold value. Thus, in FIG. 11, a sleep control circuit 4 should be configured so as to perform the same operation as that of the third embodiment.

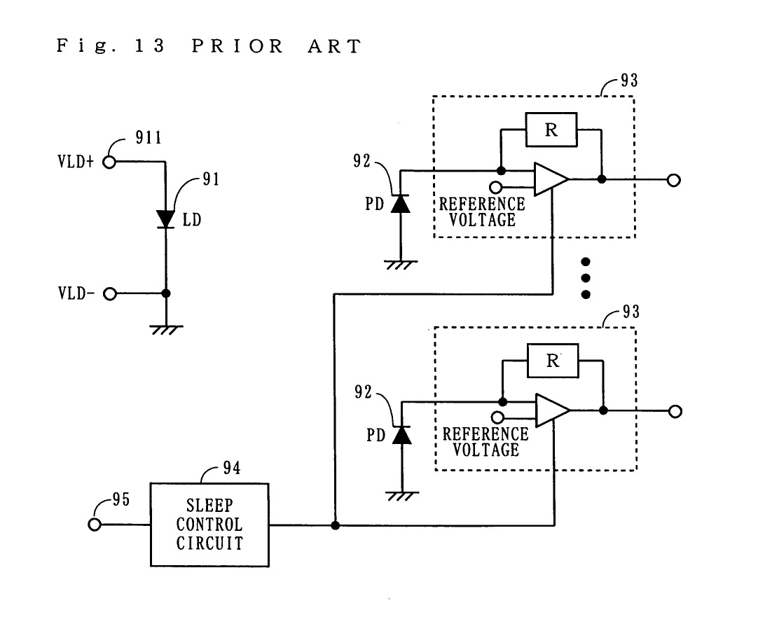

FIG. 12 is a diagram illustrating a configuration of an optical integrated device according to a variant of the fourth embodiment. In FIG. 12, the optical integrated device includes a current mirror circuit 8 having the same configuration as that shown in FIG. 8, in place of the current/voltage conversion amplifier 7 shown in FIG. 11. Except for this difference, the configuration is the same as that shown in FIG. 11. Thus, in the configuration shown in FIG. 12, as with the configuration shown in FIG. 11, if either light source 1A or 1B is in operation, current/voltage conversion amplifiers 3 are controlled to be in an operation state, and if neither light source 1A nor 1B is in operation, the current/voltage conversion amplifiers 3 are controlled to be in a sleep state.

Note that although FIGS. 9 to 12 describe the case where there are two light sources, three or more light sources may be provided. In the case where there are three or more light sources, as with the above-described case, when none of the light sources are not in operation, current/voltage conversion amplifiers 3 are controlled to be in a sleep state, and when any of the light sources is in operation, the current/voltage conversion amplifiers 3 are controlled to be in an operation state.

By combining any of the optical integrated devices according to the first to fourth embodiments with a signal processing section for performing predetermined signal processing on an output signal from the optical integrated device, a signal processing apparatus can be configured. For example, the signal processing section performs, by using an output signal from the optical integrated device, playback of an optical recording medium, a track control and a focus control when playing back the optical recording medium, or processing on a control signal for writing to the optical recording medium.

As described above, according to the present invention, a sleep control can be performed without the need to input a control signal from the outside of the optical integrated device. Accordingly, the number of terminals in the optical integrated device can be reduced. In addition, even without a sleep control terminal, by optimally performing a sleep control on the optical integrated device in the optical pickup, power saving can be achieved.

The optical integrated devices according to the present invention can be used to reduce the number of terminals or reduce power consumption by performing a sleep control.

While the invention has been described in detail, the foregoing description is in all aspects illustrative and not restrictive. It is understood that numerous other modifications and variations can be devised without departing from the scope of the invention.

1. An optical integrated device comprises:
a light source for irradiating a light beam onto an optical recording medium;
a first light-receiving element for receiving a reflected light of the light beam from the optical recording medium and outputting an electrical signal according to the reflected light;
a signal processing section for performing predetermined processing on the electrical signal outputted from the first light-receiving element; and
a sleep control circuit connected to a terminal which outputs a signal indicating an operation voltage of the light source, for controlling whether to put the signal processing section in an operation state or a low power consumption state based on the voltage at the terminal.

2. The optical integrated device according to claim 1, wherein
the voltage at the terminal and a predetermined reference voltage are inputted to the sleep control circuit, and
the sleep control circuit includes a comparator with hysteresis.

3. The optical integrated device according to claim 1, wherein the sleep control circuit puts the signal processing section in a low power consumption state when a value of the voltage at the terminal continuously indicates for a predetermined period of time that the light source is not in operation.

4. The optical integrated device according to claim 3, wherein the sleep control circuit measures the predetermined period of time using a clock signal.

5. The optical integrated device according to claim 3, further comprising:
a time measurement circuit having a capacitor which is charged by the voltage at the terminal, wherein
the sleep control circuit puts the signal processing section in a low power consumption state when a terminal voltage of the capacitor changes to a voltage less than a predetermined value.

6. The optical integrated device according to claim 1, further comprising a low-pass filter to be connected to a signal input side of the sleep control circuit.

7. An optical integrated device comprises:
a light source for irradiating a light beam onto an optical recording medium;
a first light-receiving element for receiving a reflected light of the light beam from the optical recording medium and outputting an electrical signal according to the reflected light;
a signal processing section for performing predetermined processing on the electrical signal outputted from the first light-receiving element;
a second light-receiving element for receiving the light beam irradiated from the light source, and outputting an electrical signal which indicates an amount of the light beam; and
a sleep control circuit for controlling whether to put the signal processing section in an operation state or a low power consumption state based on the electrical signal outputted from the second light-receiving element.

8. The optical integrated device according to claim 7, further comprising:
a current/voltage conversion amplifier for converting
a current value of the electrical signal outputted from the second light-receiving element into a voltage value, wherein
the sleep control circuit controls whether to put the signal processing section in an operation state or a low power consumption state based on the voltage value converted by the current/voltage conversion amplifier.

9. The optical integrated device according to claim 7, further comprising:
a current mirror circuit for amplifying a current value of the electrical signal outputted from the second light-receiving element and then converting the amplified current value into a voltage value, wherein
the sleep control circuit controls whether to put the signal processing section in an operation state or a low power consumption state based on the voltage value converted by the current mirror circuit.

10. The optical integrated device according to claim 7, wherein
a voltage whose magnitude is proportional to a current value of the electrical signal outputted from the second light-receiving element, and a predetermined reference voltage are inputted to the sleep control circuit, and
the sleep control circuit includes a comparator with hysteresis.

11. The optical integrated device according to claim 7, wherein the sleep control circuit puts the signal processing section in a low power consumption state when the electrical signal outputted from the second light-receiving element continuously indicates for a predetermined period of time that the light source is not in operation.

12. The optical integrated device according to claim 11, wherein the sleep control circuit measures the predetermined period of time using a clock signal.

13. The optical integrated device according to claim 11, further comprising:
a time measurement circuit having a capacitor which is charged by a voltage at a terminal which outputs a signal indicating an operation voltage of the light source, wherein
the sleep control circuit puts the signal processing section in a low power consumption state when a terminal voltage of the capacitor changes to a voltage less than a predetermined value.

14. The optical integrated device according to claim 7, further comprising a low-pass filter to be connected to a signal input side of the sleep control circuit.

15. A signal processing apparatus comprises:
a light source for irradiating a light beam onto an optical recording medium;
a first light-receiving element for receiving a reflected light of the light beam from the optical recording medium and outputting an electrical signal according to the reflected light;
a signal processing section for performing first predetermined processing on the electrical signal outputted from the first light-receiving element; and
a sleep control circuit connected to a terminal which outputs a signal indicating an operation voltage of the light source, for controlling whether to put the signal processing section in an operation state or a low power consumption state based on the voltage at the terminal, wherein
second predetermined processing is performed on the signal having been subjected to the first predetermined processing.

16. A signal processing apparatus comprises:
a light source for irradiating a light beam onto an optical recording medium;
a first light-receiving element for receiving a reflected light of the light beam from the optical recording medium and outputting an electrical signal according to the reflected light;
a signal processing section for performing first predetermined processing on the electrical signal outputted from the first light-receiving element;
a second light-receiving element for receiving the light beam irradiated from the light source, and outputting an electrical signal which indicates an amount of the light beam; and
a sleep control circuit for controlling whether to put the signal processing section in an operation state or a low power consumption state based on the electrical signal outputted from the second light-receiving element, wherein
second predetermined processing is performed on the signal having been subjected to the first predetermined processing.
